(19) United States
(12) Patent Application Publication
(10) Pub. No.: US 2006/0243147 A1
(43) Pub. Date: Nov. 2, 2006

(54) Offset printing press

(75) Inventor: Peer Dilling, Friedberg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/254,306

(22) Filed: Oct. 20, 2005

(30) Foreign Application Priority Data
Oct. 21, 2004 (DE) 10 2004 051 262.0

(51) Int. Cl. B41F 7/02

(52) U.S. Cl. 101/217

(57) ABSTRACT

An offset printing press includes an offset printing unit having a form cylinder, a transfer cylinder, an inking unit, a rewritable and erasable offset printing form positioned on the form cylinder, and at least one image-setting device for at least one of setting and erasing images on the rewritable and erasable offset printing form positioned on the form cylinder. The rewritable and erasable offset printing form has a seamless surface for non-repeating offset printing. An entire surface of the rewritable and erasable offset printing form has a defined roughness adapted to offset printing.

### BACKGROUND OF THE INVENTION

The present invention relates to an offset printing press having at least one offset printing unit with a form cylinder, a transfer cylinder, an inking unit, and an image-setting device for setting and/or erasing images on a rewritable and erasable offset printing form positioned on the form cylinder.

In printing processes with a fixed printing form, a distinction is made according to the prior art between offset printing, gravure printing, letterpress printing and screen printing, flexographic printing being a special form of letterpress printing. Each of these printing processes which are known from the prior art has its own strengths and weaknesses. Thus, gravure printing and flexographic printing are suitable for the non-repeating printing of, for example, packaging, wallpaper or wrapping paper. However, the production of printing forms for gravure printing and flexographic printing is complicated and expensive, with the result that so far it has not been possible to realize non-repeating printing economically with a small print run. In offset printing, printing forms can be produced considerably more inexpensively, but the offset printing presses which are known from the prior art are not suitable for non-repeating printing.

In offset printing with a fixed printing form, a distinction is made in principle between printing processes which use printing forms which can be written once and printing processes which use rewritable printing forms. The latter printing processes which use rewritable printing forms are also referred to as “computer to press/direct imaging” printing processes. The applicant markets offset printing presses under the product designation “DICOweb” which operate using rewritable and erasable printing forms. The principles of DICOweb technology are described in “Handbuch der Printmedien [Handbook of print media], Helmut Kipphan, pages 674 to 680, 2000, Springer-Verlag”. The offset printing presses which operate using rewritable and erasable printing forms have also not previously been suitable for non-repeating offset printing.

### SUMMARY OF THE INVENTION

An object of the present invention is to provide an offset printing press which operates using rewritable and erasable printing forms and with which non-repeating printing can be performed.

The object is met by an offset printing press for non-repeating offset printing in which the rewritable and erasable offset printing form has a seamless surface, wherein the entire surface of the rewritable and erasable offset printing form has a defined roughness adapted to offset printing.

For the first time, with the offset printing press according to the present invention, an offset printing press is proposed with which non-repeating offset printing can be performed. As a result, it is possible to print, for example, wallpaper, wrapping paper or else packaging by non-repeating offset printing. In the offset printing press according to the present invention which operates using rewritable and erasable printing forms, printing forms which are suitable for non-repeating printing can accordingly be produced inexpensively, with the result that non-repeating printing is then also economic for small print runs.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE PRESENTLY PREFERRED EMBODIMENTS

The printing press according to the present invention is an offset printing press which operates using rewritable and erasable printing forms. Offset printing presses of this type have a plurality of offset printing units, every offset printing unit having at least one form cylinder, one transfer cylinder, one inking unit and one damping unit. Furthermore, the offset printing units comprise at least one image-setting device, with the aid of which offset printing forms which are positioned on the respective form cylinder can have images set and erased on them. In order to set images on the offset printing forms, image-setting material is moved in the direction of the form cylinder and applied to the surface of the offset printing form. Here, the image-setting material is preferably stored on a roll or a transfer ribbon and is transferred to the surface of the offset printing form which is to have images set on it via a thermal transfer process with the aid of a laser. The image-setting material is preferably polymer material. Although the application of the image-setting material via a transfer ribbon and a laser which interacts with the transfer ribbon is preferred, it is to be noted at this point that it goes without saying that the image-setting material can also be applied to the surface of the offset printing form which is to have images set on it via one or more inkjet nozzles.

To make non-repeating offset printing possible in an offset printing press of this type which operates using rewritable and erasable offset printing forms, the present invention uses rewritable and erasable offset printing forms with a seamless surface. Furthermore, the seamless surface of the rewritable and erasable offset printing form is configured in such a way that the entire surface of the offset printing form has a defined roughness or roughness depth which is adapted to offset printing. As a result, it becomes possible to set images seamlessly on the rewritable and erasable offset printing form via the respective image-setting device. For this purpose, image-setting material is supplied continuously to the respective image-setting device, the image-setting material preferably being applied seamlessly to the surface of the offset printing form with the aid of a laser.

The seamless offset printing form, the surface of which has a roughness which is adapted to offset printing, is preferably a welded sleeve made from steel, a welded seam of the sleeve being processed by a superfinishing process (in particular, grinding) such that the total surface of the sleeve has a roughness which is adapted to offset printing. This provides a seamless surface which is suitable for offset printing. The surface of the welded sleeve made from steel is preferably set to the required roughness by grinding, in particular by rough-grinding and finish-grinding. In the context of the present invention, it is possible as an alternative to configure the or every rewritable and erasable offset printing form as a seamless, galvanically manufactured sleeve. Galvanically manufactured sleeves of this type are preferably nickel sleeves which are coated seamlessly to provide a surface which is suitable for offset printing. A sleeve of this type made from nickel is preferably coated galvanically, as has already been described, or by a PVD coating process or by thermal spraying such as flame spraying. As a result, the surface of the seamless nickel sleeve is coated with chrome or a ceramic, to provide a hydrophilic functional layer on the surface of the said nickel sleeve. An image-setting material, in particular an ink-friendly polymer, can be applied to this functional layer with the aid of an image-setting device, in order to set images seamlessly on the offset printing form which has been prepared in this way.

For the first time, non-repeating offset printing is made possible by the offset printing press according to the present invention. The core concept of the invention lies in the provision of an offset printing press which operates using rewritable and erasable offset printing forms, the rewritable and erasable offset printing forms having a seamless surface and it being possible to set images on them seamlessly by means of an image-setting device. For this purpose, the seamless offset printing form has a roughness which is adapted to offset printing in the region of its entire surface.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An offset printing press comprising an offset printing unit having a form cylinder, a transfer cylinder, an inking unit, a rewritable and erasable offset printing form positioned on said form cylinder, and at least one image-setting device for at least one of setting and erasing images on said rewritable and erasable offset printing form positioned on said form cylinder, wherein said rewritable and erasable offset printing form has a seamless surface for non-repeating offset printing, wherein said entire seamless surface of said rewritable and erasable offset printing form has a defined roughness adapted to offset printing.

2. The offset printing press of claim 1, wherein said image-setting device is arranged and dimensioned for seamlessly setting images on said rewritable and erasable offset printing form.

3. The offset printing press of claim 2, wherein said image-setting device is supplied continuously with image-setting material and comprises a laser seamlessly applying said image-setting material onto said surface of said rewritable and erasable offset printing form.

4. The offset printing press of claim 1, wherein said rewritable and erasable offset printing form comprises a welded sleeve having a welded seam processed by a superfinishing process such that said entire surface of the sleeve has a defined roughness adapted to offset printing.

5. The offset printing press of claim 4, wherein said surface and said welded seam of said welded sleeve are set to the defined roughness by a grinding process including rough-grinding with subsequent finish-grinding.

6. The offset printing press of claim 1, wherein said rewritable and erasable offset printing form comprises a seamless and galvanically manufactured sleeve coated seamlessly with a coating providing a surface suitable for offset printing.

7. The offset printing press of claim 6, wherein said surface of said sleeve is coated seamlessly by a PVD coating process.

8. The offset printing press of claim 6, wherein said surface of said sleeve is coated seamlessly by thermal spraying.

9. The offset printing press of claim 6, wherein said surface of said sleeve is coated seamlessly by a galvanic application of chromium.

10. The offset printing press of claim 4, wherein said welded sleeve comprises a welded steel sleeve.

11. The offset printing press of claim 6, wherein said sleeve comprises a galvanically manufactured nickel sleeve.

12. The offset printing press of claim 8, wherein said thermal spraying comprises flame spraying.

13. A process of non-repeating printing comprises using an offset printing press for non-repeating offset printing, the offset printing press comprising an offset printing unit having a form cylinder, a transfer cylinder, an inking unit, a rewritable and erasable offset printing form positioned on said form cylinder, and at least one image-setting device for at least one of setting and erasing images on the rewritable and erasable offset printing form positioned on the form cylinder, wherein the rewritable and erasable offset printing form has a seamless surface for non-repeating offset printing, and an entire surface of the rewritable and erasable offset printing form has a defined roughness adapted to offset printing.
